(19) United States
(12) Patent Application Publication
(10) Pub. No.: US 2025/0390764 A1
(43) Pub. Date: Dec. 25, 2025

(54) CONSERVING COMPUTING RESOURCES BY DETECTING DUPLICATE ACTION EXECUTION REQUESTS

(71) Applicant: Truist Bank, Charlotte, NC (US)

(72) Inventors: Murali Mohanan, Marietta, GA (US); Deepak Janke, Charlotte, NC (US)

(73) Assignee: Truist Bank, Charlotte, NC (US)

(21) Appl. No.: 18/748,745

(22) Filed: Jun. 20, 2024

(51) Int. Cl. G06N 5/022

(52) U.S. Cl. CPC G06N 5/022

(57) ABSTRACT

A computing system for determining the presence of one or more duplicate action execution requests among multiple received action execution requests is disclosed. The system can train a machine-learning model on training data including historical action execution information associated with a plurality of historical actions executed by one or more action execution applications, to generate a trained a machine-learning model. The trained machine-learning model can subsequently identify duplicate requests among newly received action execution requests by recognizing patterns in associated action execution information received with the action execution requests. An action execution request that is determined to be a duplicate action execution request by the trained a machine-learning model can then be identified for removal or automatically removed from the system.

### TECHNICAL FIELD

The present disclosure relates generally to computing networks, and more particularly, although not exclusively, to conserving computing and user resources by detecting duplicate electronic action execution requests prior to action execution.

### BACKGROUND

Action execution requests from an initiating party to a receiving party may be electronically sent on a routine basis for diverse purposes. An electronic action execution request may be transmitted via an electronic message, which can include information that is useful to enable a computing network of the receiving party to fulfill the request. A request to execute an action transmitted by an initiating party to a receiving party may be for the benefit of a third party. Review and execution of requested actions can consume significant memory, processor, and user resources, particularly given that a receiving party can receive numerous action execution requests on a daily basis. Occasionally, a request to execute the same action may be inadvertently sent by an initiating party to a receiving party more than once. Unintended duplicate execution of the same requested action can unnecessarily consume memory, processor, and human resources of the receiving party. Unintended duplicate execution of the same requested action may also adversely affect accounts, inventory, or other interests of one or more of an initiating party, a receiving party, or a third party.

### SUMMARY

According to one example of the present disclosure, a system may include a processor, and a memory that is communicatively coupled to the processor and includes instructions that are executable by the processor to cause the processor to perform operations. The operations may include accessing training data comprising historical action execution information associated with a plurality of historical actions executed by one or more action execution applications. The operations may also include training a machine-learning model on the training data to produce a trained machine-learning model trained to detect a duplicate action execution request by recognizing one or more patterns within the historical action execution information. The operations may additionally include receiving a plurality of action execution requests for execution, each action execution request of the plurality of action execution requests including action execution information, and temporarily placing the plurality of action execution requests in a future execution queue to await future execution by the one or more action execution applications. The operations may further include providing, as input data to the trained machine-learning model, the action execution information associated with the action execution requests in the future execution queue, and generating, by the trained machine-learning model, an output determining that an action execution request of the action execution requests in the future execution queue is a duplicate action execution request. The operations may yet further include outputting a notification identifying the duplicate action execution request for removal from the future execution queue.

According to a another example of the present disclosure, a computer-implemented method may include receiving, by a processor, a plurality of action execution requests, each action execution request including action execution information. The method may also include temporarily placing the plurality of action execution requests in a future execution queue to await future execution by one or more action execution applications. The method may additionally include providing, by the processor, the action execution information as input to a trained machine-learning model previously trained on training data comprising historical action execution information associated with a plurality of historical actions executed by one or more action execution applications to detect a duplicate action execution request within the plurality of historical action execution requests by recognizing one or more patterns within the historical action execution information. The method may further include generating, by the trained machine-learning model, an output determining that an action execution request of the plurality of action execution requests in the future execution queue is a duplicate action execution request, and removing the duplicate action execution request from the future execution queue.

According to a further example of the present disclosure, a non-transitory computer readable medium may contain instructions that are executable by a processor to cause the processor to perform operations. The operations may include accessing training data comprising historical action execution information associated with a plurality of historical actions executed by one or more action execution applications. The operations may also include training a machine-learning model on the training data to produce a trained machine-learning model trained to detect a duplicate action execution request by recognizing one or more patterns within the historical action execution information. The operations may additionally include receiving a plurality of action execution requests for execution, each action execution request of the plurality of action execution requests including action execution information, and temporarily placing the plurality of action execution requests in a future execution queue to await future execution by the one or more action execution applications. The operations may further include providing, as input data to the trained machine-learning model, the action execution information associated with the action execution requests in the future execution queue, and generating, by the trained machine-learning model, an output determining that an action execution request of the action execution requests in the future execution queue is a duplicate action execution request. The operations may yet further include outputting a notification identifying the duplicate action execution request for removal from the future execution queue.

### BRIEF DESCRIPTION OF THE DRAWINGS

FIG. 1 is a block diagram of a machine-learning-based system for detecting duplicate action execution requests, according to an example of the present disclosure.

FIG. 2 is a block diagram of an application for training a machine-learning model to detect duplicate action execution requests, according to an example of the present disclosure.

FIG. 3 is a block diagram illustrating various computing components of the machine-learning-based system of FIG. 1, according to an example of the present disclosure.

FIG. 4 is a flowchart of a computer-implemented method for detecting duplicate action execution requests, according to one example of the present disclosure.

### DETAILED DESCRIPTION

Certain aspects and features of the present disclosure relate to a machine-learning-based system that can conserve computing resources while addressing requests to execute actions, by detecting duplicate action execution requests and correspondingly avoiding execution of duplicate actions. Action execution requests may be received by the system from an initiating party over a network. Action execution requests may be received by the system from an initiating party device over one or more different channels. The system may be a distributed computing system. In some examples, the system may be a cloud-based computing system that utilizes one or more physical or virtual servers of a cloud service provider. The system may include a trained machine-learning model to detect duplicate action execution requests, and one or more action execution applications to execute non-duplicate actions. An action execution application may be computer-executable code, such as a program or software, which can understand the format and content of incoming action execution requests.

In some examples, a computing system for executing a requested action can include multiple components and layers. In some examples, the trained machine-learning model may detect duplicate action execution requests by recognizing patterns in action execution information associated with received action execution requests. In some examples, the action execution requests may be received in batches, processed in batches, or both.

System examples may access training data and may train the machine-learning model on the training data to generate a trained machine-learning model. The training data may include data associated with one or more historical action execution requests received by the system. For example, when the action execution requests are wire transfer requests or requests to execute other transactions, the training data may include initiating party and third party names, third party financial institution names, account numbers, routing numbers, credit or debit transaction amounts, etc. The training data may also include historical date or time information related to the action execution requests, such as might be associated with action execution requests that are made by an initiating party on a recurring basis.

When provided with input in the form of a newly received action execution request or a group of newly received action execution requests, the trained machine-learning model can generate an output indicating the presence of a duplicate action execution request(s). The duplicate action execution request can then be identified for removal or automatically removed from the system, such as from a batch of requested actions awaiting execution in a queue. Removing duplicate action execution requests can conserve computing resources by eliminating the possibility of inadvertently executing the same action more than once.

In some examples, where the system executes requested actions in sequentially-scheduled batches, the system may impose a time delay between the receipt of preceding and succeeding batches to allow for duplicate action request detection. Similarly, in an example where multiple action execution requests (such as batches of action execution requests) are placed in a queue of the system to await future execution by one or more action execution applications, the system may impose a timed delay between the receipt of the action execution requests in the queue and the subsequent transmission of the action execution requests from the queue to the downstream action execution application(s). Such a time delay may be provided to allow the trained machine-learning model adequate time to detect duplicate action execution requests among the action execution requests in the queue. Unnecessary transmission of duplicate requests and unintended execution of duplicate actions can thus be avoided.

In one example, a computing system for detecting duplicate action execution requests may be a wire transfer processing system of a financial institution. In some examples, the wire transfer processing system may be deployed in a cloud-computing environment where one or more wire transfer initiation applications execute on one or more physical or virtual servers of a cloud service provider. In some examples, communications between an initiating party and the wire transfer processing system may occur over the Internet and may be initiated by the initiating party using a web browser-enabled device. A machine-learning model may be employed to identify duplicate wire transfer requests among the received wire transfer requests. For example, the machine-learning model may identify duplicate requests by analyzing patterns in action execution information received with the action execution requests, or by applying other AI analysis techniques. The wire transfer requests not identified as duplicates by the machine-learning model may then be processed by the wire transfer initiation application(s), or the wire transfer initiation application(s) may cause another application or computing system to execute the wire transfers. Executing a wire transfer can cause a transfer of funds from an account associated with the initiating party to an account associated with a third party identified in the corresponding wire transfer request. In some examples, the initiating party may be a customer of the financial institution or may be another financial institution. In other examples, an action execution request may be an internal request, such as may emanate from an employee or a group or department of the financial institution.

These illustrative examples are provided to introduce the reader to the general subject matter discussed herein, and are not intended to limit the scope of the disclosed concepts. In the following description, various additional features and examples are described with reference to the drawings in which like numerals indicate like elements. Various implementations may be practiced without these specific details, and features can be combined together. The figures and description are not intended to be restrictive.

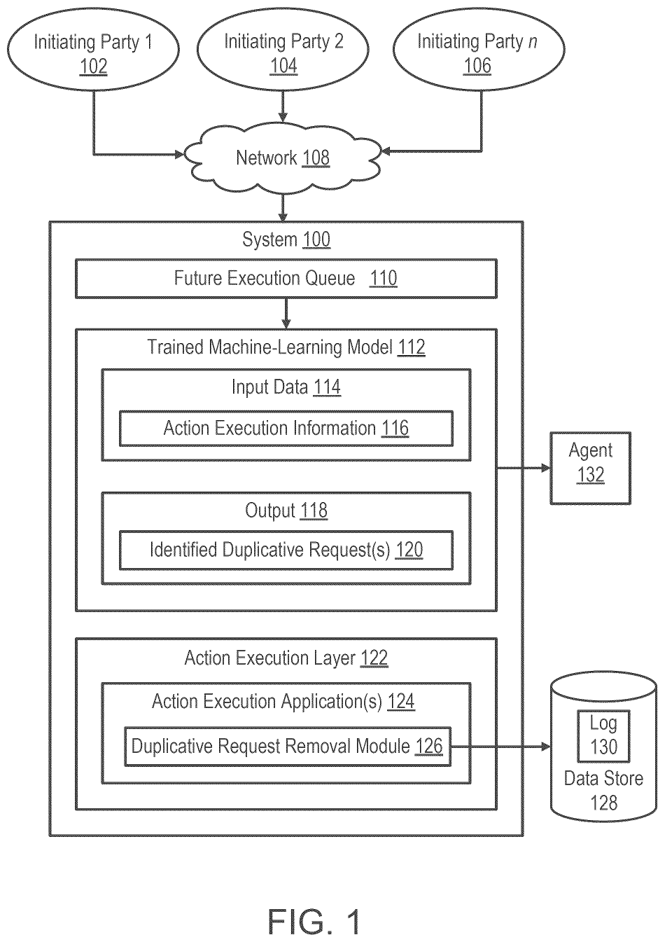

FIG. 1 is a block diagram illustrating one example of a machine-learning-based computing system 100 for detecting duplicate action execution requests. The computing system 100 can determine when an individual action execution request within a number of synchronously or asynchronously transmitted action execution requests is a duplicate request. The computing system 100 can also detect duplicate requests within a plurality of action execution requests received as a group, such as within one or more batches of received action execution requests.

In some examples, the computing system 100 may be operated by the receiving party of the action execution requests. In other examples, the computing system 100 may be operated on behalf of the receiving party of the action execution requests. In some examples, the computing system 100 may be a computing system of an entity such as a financial institution that receives action execution requests from one or more initiating parties.

The computing system 100 can include various processing and other hardware and software or application components. The computing system 100 may be a standalone computing system such as a desktop or laptop computer, a mobile device, etc. In other examples, the computing system 100 may be a server, or a distributed computing system having multiple servers, virtual machines, etc. In still other examples, the computing system 100 may be a cloud-based computing system that utilizes one or more physical or virtual servers of a cloud service provider.

The computing system 100 may receive multiple action execution requests from different initiating parties 102, 104, 106, or multiple action execution requests from the same one of the receiving parties 102, 104, 106. The action execution requests may be received via various channels from initiating party devices (e.g., desktop or laptop computers, mobile devices, etc.). In one example, the channel may be a wire transfer channel (e.g., SWIFT, Fedwire). The action execution requests may be transmitted to the computing system 100 over a network 108, the nature of which may vary based on the identity of the initiating party 102, 104, 106. For example, the network 108 can be a local area network (LAN), a wide-area network (WAN) such as the Internet, an institutional network, cellular or other wireless networks, virtual networks such as an intranet or an extranet, etc.

In examples where action execution requests are received by the computing system 100 in batches, each received batch may contain numerous action execution requests. In other examples, the computing system 100 may organize individually-received action execution requests into batches after receipt. In either case, a batch of individually-received action execution requests or one or more received batches of action execution requests may, in some examples, be temporarily placed in a future execution queue 110 to await execution. The action execution requests in the future execution queue 110 may thereafter be transferred downstream within the computing system 100 for action execution at a scheduled future time. In other examples, received action execution requests may be determined to be or to not be duplicates in substantially real time.

As depicted, the computing system 100 can include a trained machine-learning model 112. The trained machine-learning model 112 can be provided with input data 114. The input data 114 may include action execution information 116 that is associated with and accompanies each of the received action execution requests. For example, when an action execution request is a wire transfer request, the action execution information 116 may include a wire transfer amount, an execution (value) date, a sender's name, the intended recipient's name, addresses, account numbers, and routing numbers. Additional information (e.g., a bank SWIFT codes) may be included if the wire transfer requests correspond to a permitted type of international wire transfer.

Based on the input data 114, the trained machine-learning model 112 can be configured to generate an output 118. The output 118 may be, or may include a determination that one or more of the action execution requests associated with the action execution information 116 input to the trained machine-learning model 112 is a duplicate action execution request 120. The trained machine-learning model 112 may determine the presence of the one or more duplicate action execution requests by various techniques described in more detail below.

When the computing system 100 detects a duplicate action execution request 120, the computing system 100 may identify the duplicate action execution request 120 for manual removal or may automatically remove the duplicate action execution request 120 from the system before the duplicate action execution request 120 can be sent downstream for execution of the associated action. For example, the duplicate action execution request 120 may be removed from the future execution queue 110. In some examples, the computing system 100 may include a duplicate action execution request removal module 126 that is configured to remove duplicate action execution requests 120 from the future execution queue 110 or otherwise from the computing system 100. The duplicate action execution request removal module 126 may be, for example, code that can be included in an action execution application 124 of an action execution layer 122 of the computing system 100.

The action execution layer 122 of the computing system 100 may be configured to execute requested actions that have been received by the computing system 100 and determined by the trained machine-learning model 112 to be not duplicative of other requested actions. In some examples, the action execution layer 122 may include one or more action execution components such as one or more processors, servers, virtual machines, etc. In some examples, the one or more action execution components may be arranged in a distributed server architecture, in which case at least some of the one or action execution components can reside in different locations and may communicate with other layers of the computing system 100 and with each other over one or more networks. In some examples, the action execution layer 122 of the computing system 100 may include one or more physical or virtual servers associated with a cloud-based computing system of a cloud service provider.

One or more applications such as for example, one or more action execution applications 124, may be executed by the action execution components of the computing system 100. In some examples, the one or more action execution applications 124 may be wire transfer processing applications for processing different types of wire transfers. In some examples, a given action execution component may be configured to run an action execution application 124 or multiple action execution applications 124 specific to processing a particular type of action—e.g., international (SWIFT) wire transfers when the action is a wire transfer. In other examples, a given action execution component may be configured to run multiple action execution applications 124 that allow the given action execution component to process different types of actions—e.g., domestic (FedWire) and international (SWIFT) wire transfers when the action is a wire transfer. Combinations of such action execution component configurations may also be employed in some system examples.

The computing system 100 can further include other layers and components. For example, the computing system 100 may include a data store 128 that is communicatively coupled to at least the duplicate action execution request removal module 126. The data store 128 may include a data log 130 where, for example, identified duplicate action execution requests 120 may be logged or stored upon detection by or removal from the computing system 100. In some examples, the data store 128 may be a component of a data systems layer. The data systems layer can include one or more additional data stores such as database servers, the number and location of which may vary depending on the specific design of the computing system 100. For example, the database servers may be arranged in a distributed server architecture where at least some of the database servers can reside in different locations and may communicate with other layers of the computing system 100 and with each other over one or more networks. The database servers may also be in communication with one or more databases, such that the database servers can retrieve action-related data from, or store action-related data to, the databases as needed during the execution of requested actions.

Various layers of the computing system 100 may each include one or more applications that cooperate to form separate processing pipelines. For example, applications executing on other layers of the computing system 100 may cooperate with the action execution application(s) 124 of the action execution layer 122 to form a processing pipeline by which action execution requests can be received and queued for future execution, duplicate action execution requests can be removed, and non-duplicative action requests can be executed.

In examples where the computing system 100 receives and executes requested actions in sequentially-scheduled batches, the computing system 100 may impose a time delay between the receipt of preceding and succeeding batches to allow for duplicate action request identification. In examples where the computing system 100 is configured to temporarily place received action execution requests (such as batches of received action execution requests) in the future execution queue 110 to await future execution by the one or more action execution applications 124, the computing system 100 may impose a time delay between the receipt of the action execution requests in the future execution queue 110 and subsequent transmission of the action execution requests from the future execution queue 110 downstream to the one or more action execution applications 124. Such a time delay(s) can provide the trained machine-learning model 112 with time to identify duplicate action execution requests before the duplicate action execution requests can be sent for execution of the associated actions.

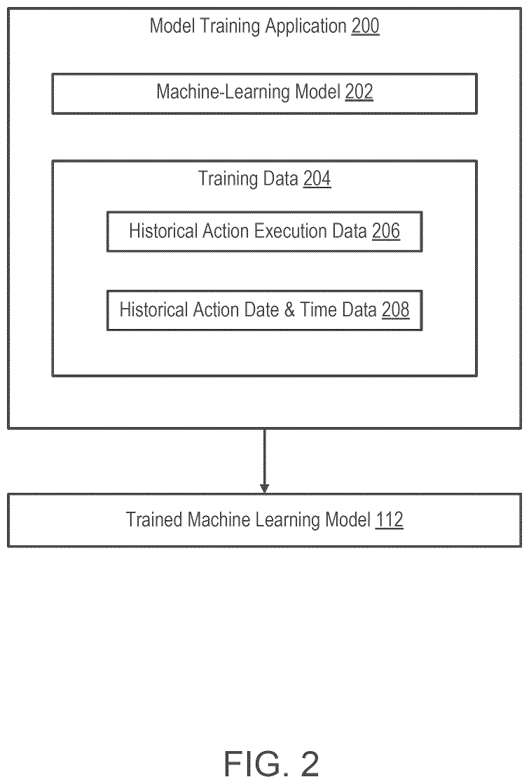

FIG. 2 is a block diagram of one example of a model-training application 200 that can train a machine-learning model 202. Training the machine-learning model 202 can transform the machine-learning model 202 from an untrained state to a trained state—i.e., to a trained machine-learning model such as the trained machine-learning model 112 of FIG. 1. The model-training application 200 can be part of the computing system 100 of FIG. 1, or the model-training application 200 may be separate and remote from the computing system 100 but communicatively coupled thereto.

Training the machine-learning model 202 can include accessing training data 204. In some examples, the training data 204 can be stored in a data repository that can be accessed by the model-training application 200. The training data 204 may result from subjecting data, such as existing past transaction data, to various preprocessing and feature extraction operations. For example, one or more feature extraction operations may be performed to extract from the data, historical action execution data 206 associated with one or more historical actions executed by the computing system 100 (e.g., by the action execution application(s) 124). The historical action execution data 206 may identify the specific types of actions that were executed by the computing system 100. Use of the historical action execution data 206 as part of the training data 204 can facilitate identification of duplicate action execution requests by the trained machine-learning model 112. For example, the trained machine-learning model 112 may be able to identify common characteristics of duplicate action execution requests, such as transactions with similar amounts occurring within a short time frame, transactions with identical account numbers, etc. In some examples, historical action execution date and time data 208 may also be extracted from the data and added to the training data 204.

The training data 204 can be used to train the machine-learning model 202 to identify duplicate action execution requests by recognizing patterns in the training data 204. Various algorithms can be employed for training the machine-learning model 202 in pattern recognition. For example, clustering algorithms like k-means clustering or density-based clustering may be used to group similar transactions together and make it easier to identify duplicates. Artificial intelligence algorithms or a series of algorithms, such as for example, decision trees, random forests, support vector machines, and neural networks may also be used to train the machine-learning model 202 in pattern recognition. In some examples, it may also be possible to utilize sequence matching algorithms such as Levenshtein distance or dynamic time warping to compare action execution request information, such as transaction sequences, to detect similarities.

Thresholds or other rules may be employed during training of the machine-learning model 202. When applied, thresholds can act as decision criteria for classifying (identifying) an action execution request in the training data 204 as a duplicate action execution request. For example, a first threshold may define a degree of similarity between action execution information that is required in order for an action execution request associated with a pattern detected by the machine-learning model 202 to be identified as a duplicate request. Such an information similarity threshold may apply to only certain items of information within the action execution information or to the overall content of the action execution information for each action execution request. Another threshold may define a time interval within which action execution requests must be received for an action execution request associated with a pattern detected by the machine-learning model 202 to be identified as a duplicate request. For example, when such a time interval threshold is defined, the machine-learning model 202 may determine that a given action execution request is a duplicate of another action execution request only if the time interval between receipt of the action execution requests is within the threshold time interval. Thresholds applied during the training of the machine-learning model 202 may be finetuned to minimize false positives or negatives.

Various other fitting, estimation, or model-training optimization techniques can be used to ensure that, upon evaluation, the predictive output of the machine-learning model 202 is accurate given the input (training) data 204 (i.e., to minimize the loss function). For example, the training data 204 can be provided to the machine-learning model 202 in an iterative manner to enable the machine-learning model to identify trends or relationships in the training data 204. In some examples, the machine-learning model 202 may be trained in a supervised manner. In other examples, the machine-learning model 202 may be trained in an unsupervised manner, or a semi-supervised manner. Training the machine-learning model 202 can involve adjusting a parameter or a hyperparameter of the machine-learning model 202 to minimize a loss function of the machine-learning model 202.

After training of the machine-learning model 202 is complete, the resulting trained machine-learning model 112 can be deployed for application to newly received input data 114. More particularly, as described with respect to FIG. 1, action execution information 116 newly received by the computing system 100 along with one or more new action execution requests can be provided to the trained machine-learning model 112 as input data 114. The trained machine-learning model 112 can recognize an individually-received action execution request as a duplicate request using the above-described pattern recognition techniques. For example, an individually-received action execution request may be evaluated in light of other action execution requests received (individually or in one or more batches) within some predetermined time period. The trained machine-learning model 112 can also recognize duplicate action execution requests within a batch or other collection of action execution requests whose associated action execution information is provided as input to the trained machine-learning model 112. For example, each action execution request within a batch of action execution requests may be evaluated in light of other action execution requests in the batch as well as other action execution requests received individually or in one or more other batches. In some examples, such an evaluation may be bound by a time constraint, where only action execution requests received within some predetermined period of time or within some allowable interval of time therebetween are analyzed. In any case, the trained machine-learning model 112 can generate an output 118 that includes an indication of one or more duplicate action execution requests 120 among the received action execution requests.

In some examples, a notification can be issued if the trained machine-learning model 112 recognizes a duplicate action execution request. A generated notification may identify or otherwise indicate the duplicate action execution request(s). The notification may also include a suggested additional action, such as manual removal of the duplicate action execution request, manual review of a duplicate action execution request automatically removed by the computing system 100, or a related voiding or updating of records relating to the duplicate action execution request.

Despite an action execution request containing substantially the same information as one or more other action execution requests, some examples of the trained machine-learning model 112 can recognize such an action execution request as a non-duplicative but recurring action execution request. For example, the trained machine-learning model may recognize one or more recurring patterns within action execution information that is associated with a plurality of action execution requests and is provided as input data to the trained machine-learning model 112. For example, there may be cases where a given party routinely and repeatedly transmits action execution requests that are substantially similar, such as in the case of recurring payments of the same amount to the same receiving party. In such an example, the trained machine-learning model 112 may recognize patterns involving a like payee, like payment amounts, related payment dates (e.g., the first day of each month), like account numbers, or patterns involving combinations of such information and other information. The trained machine-learning model 112 may recognize patterns indicative of recurring action execution requests whether the action execution requests are transmitted synchronously, or asynchronously, and in cases where received action execution requests are arranged into groups for subsequent sequential (batch) processing.

Based on determining that an action execution request is a recurring action execution request, some examples of the trained machine-learning model may configure an agent 132 for generating future occurrences of the recurring action execution requests. This can save future computing and human resources by automating the generation and transmission of recurring action execution requests. The agent 132 may act as a template for future occurrences of the recurring action execution requests. Configuring the agent 132 may include defining operational parameters for the agent 132 and request information for inclusion in the future occurrences of the recurring action execution requests. The operational parameters for the agent 132 may include, among other things, one or more of identification, timing, and communication parameters. Such operational parameters may be used, for example, to name the agent, to define an operating frequency or interval, to define monitoring functions, to define protocols (e.g., API specifications) for agent communications with other systems or with users, etc.

In some examples, configuring the agent 132 may further include extracting recurring action execution information from a larger totality of action execution information associated with the recurring action execution request. Configuring the agent 132 can also include receiving input data from a user of the system. In some examples, input data may be provided by a user as a natural language utterance.

In some examples, the recurring action execution request may be a recurring wire transfer request and the request information for inclusion in future occurrences of the recurring wire transfer requests may include, for example, one or more of initiating party account information, a recipient name, recipient account information, and a wire transfer amount. In any case, once configured, the agent 132 may be deployed to generate the future occurrences of the recurring action execution requests based on the operational parameters.

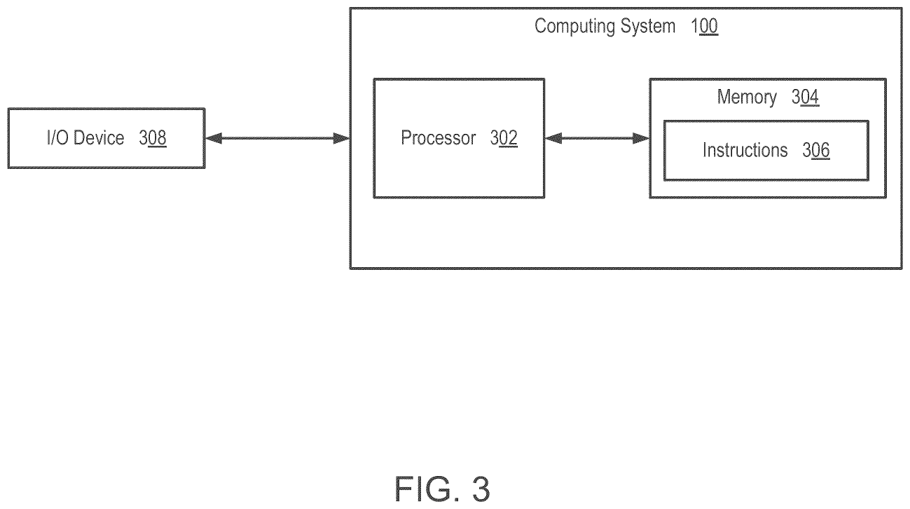

FIG. 3 is a block diagram illustrating various components of a computing system, such as the computing system 100 of FIG. 1, that is usable to detect duplicate action execution requests within a batch or between batches of action execution requests. As illustrated, the computing system 100 may include a processor 302 that is communicatively coupled to a memory 304. The processor 302 can include one processing device or multiple processing devices. Non-limiting examples of the processor 302 include a Field-Programmable Gate Array (FPGA), an application-specific integrated circuit (ASIC), a microprocessor, etc. The processor 302 can execute instructions 306 stored in the memory 304 to perform operations. In some examples, the instructions 306 can include processor-specific instructions generated by a compiler or an interpreter from code written in a suitable computer-programming language, such as C, C++, C#, etc.

The memory 304 can include one memory or multiple memories. The memory 304 can be non-volatile and may include any type of memory that retains stored information when powered off. Non-limiting examples of the memory 304 include electrically erasable and programmable read-only memory (EEPROM), flash memory, or any other type of non-volatile memory. At least some of the memory 304 can be a non-transitory computer-readable medium from which the processor 302 can read the instructions 306. A computer-readable medium can include electronic, optical, magnetic, or other storage devices capable of providing the processor 302 with computer-readable instructions or other program code. Non-limiting examples of a computer-readable medium include magnetic disk(s), memory chip(s), ROM, random-access memory (RAM), an ASIC, a configured processor, optical storage, or any other medium from which the processor 302 can read the instructions 306. In some examples, the memory 304 may include the trained machine-learning model 112.

The computing system 100 may additionally include one or more input/output (I/O) components. For example, the computing system 100 can include an I/O device 308 communicatively coupled to the computing system 100. Additionally, or alternatively, the computing system 100 can include other I/O components that are not shown for simplicity. Examples of input components can include a mouse, a keyboard, a trackball, a touch pad, a touch-screen display, etc. Examples of output components can include a visual display or an audio display. Examples of the visual display can include a liquid crystal display (LCD), a light-emitting diode (LED) display, or the touch-screen display. An example of the audio display can include speakers. In some cases, the I/O components can be integrated into a single structure that can be communicatively coupled to the computing system 100. For example, the I/O components may be positioned within the I/O device 308. In other examples, the I/O components can be distributed (e.g., in separate housings) and in electrical communication with each other and the computing system 100.

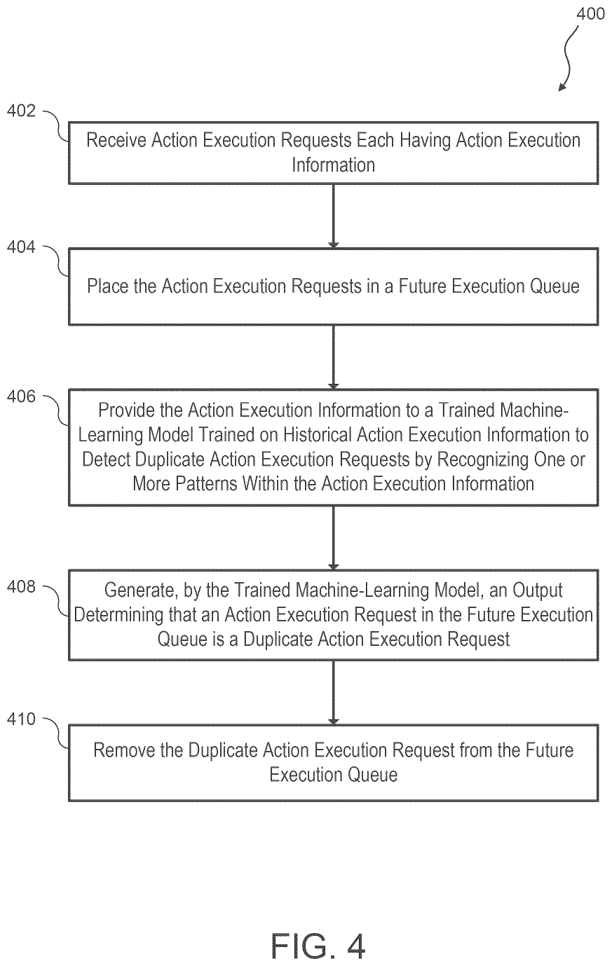

FIG. 4 is a flowchart 400 of a computer-implemented method for recognizing duplicate action execution requests among a plurality of received action execution requests. The computer-implemented method may be performed by a machine-learning-based computing system, such as the computing system 100 described relative to FIG. 1.

As represented in block 402, a plurality of action execution requests may be received by a processor. Each of the action execution requests may include various types of action execution information. For example, when the action execution requests are wire transfer requests, each action execution request may include action execution information, such as party information, account information, financial institution information, and a future value date.

At block 404, the action execution requests may be temporarily placed in a future execution queue. The action execution requests may be temporarily placed in the future execution queue to await future execution by one or more downstream action execution applications. The one or more downstream action execution applications may execute in an action execution layer of the computing system. In some examples, a time delay may be imposed between receiving action execution requests in the future execution queue and transferring the action execution requests from the future execution queue to the action execution application(s), to provide adequate time for duplicate action execution request detection.

At block 406, the processor can provide the action execution information to a trained machine-learning model. The trained machine-learning model may have been previously trained on training data comprising historical action execution data associated with a plurality of historical actions executed by one or more action execution applications to detect a duplicate action execution request within the plurality of historical action execution requests by recognizing one or more patterns within the historical action execution information. The historical action execution data may also include historical action execution date and time data. In some examples, the patterns may be associated with common characteristics of duplicate action execution requests, such as transactions with similar amounts occurring within a short time frame, transactions with identical account numbers, etc.

At block 408, the trained machine-learning model can generate an output determining that an action execution request of the plurality of action execution requests in the future execution queue is a duplicate action execution request. As indicated at block 410, the duplicate action execution request can then be removed from the future execution queue. In some examples, the duplicate action execution request can be removed from the future execution queue by a duplicate action execution request removal module. The duplicate action execution request removal module may be code that has been developed for this purpose. In some examples, the code may be included in an action execution application of the computing system.

In one example, a computing system for detecting duplicate action execution requests may be a wire transfer processing system of a financial institution. The wire transfer processing system may be deployed in a cloud-computing environment where one or more wire transfer initiation applications execute on one or more physical or virtual servers of a cloud service provider. In some examples, communications between an initiating party and the wire transfer processing system may occur over the Internet and may be initiated by the initiating party using a web browser-enabled device. A trained machine-learning model may be employed to identify duplicate wire transfer requests. For example, the trained machine-learning model may be trained to identify duplicate wire transfer requests by analyzing patterns associated with the wire transfer execution information associated with the wire transfer requests. A wire transfer request not identified by the trained machine-learning model as a duplicate request may then be processed by the wire transfer execution application(s), or the wire transfer execution application(s) may cause another application or computing system to execute the wire transfers. Executing a wire transfer can cause a transfer of funds from an account associated with the initiating party to an account associated with a third party identified in the wire transfer request. In some examples, the initiating party may be a customer of the financial institution or may be another financial institution. In other examples, a wire transfer request may be an internal request, such as may emanate from an employee or a group or department of the financial institution.

The foregoing description of certain examples, including illustrated examples, has been presented only for purposes of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processor;
a memory communicatively coupled to the processor, the memory including instructions that are executable by the processor to cause the processor to perform operations comprising:
accessing training data comprising historical action execution information associated with a plurality of historical actions executed by one or more action execution applications;
training a machine-learning model on the training data to produce a trained machine-learning model trained to detect a duplicate action execution request by recognizing one or more patterns within the historical action execution information;
receiving a plurality of action execution requests for execution, each action execution request of the plurality of action execution requests including action execution information;
temporarily placing the plurality of action execution requests in a future execution queue to await future execution by the one or more action execution applications;
providing, as input data to the trained machine-learning model, the action execution information associated with the action execution requests in the future execution queue;
generating, by the trained machine-learning model, an output determining that an action execution request of the action execution requests in the future execution queue is a duplicate action execution request; and
outputting a notification identifying the duplicate action execution request for removal from the future execution queue.

2. The system of claim 1, wherein the historical action execution information includes historical action execution date and time data.

3. The system of claim 1, wherein the machine-learning model is trainable by supervised learning using an artificial intelligence algorithm or series of algorithms selected from the group consisting of a decision tree, a random forest, a support vector machine, and a neural network.

4. The system of claim 1, wherein the operations further comprise, during training of the machine-learning model, applying a threshold selected from the group consisting of:
a first threshold that defines a degree of similarity between action execution information that is required in order for an action execution request associated with a pattern detected by the machine-learning model to be identified as a duplicate request;
a second threshold that defines a time interval within which an action execution request associated with a pattern detected by the machine-learning model must be received to be identified as a duplicate request; and
a combination thereof.

5. The system of claim 1, wherein the operations further comprise imposing a time delay between placing the plurality of action execution requests in the future execution queue and transmitting the plurality of action execution requests from the future execution queue to the one or more action execution applications for execution of the actions.

6. The system of claim 1, further comprising a duplicate action execution request removal module to remove identified duplicate action execution requests from the future execution queue.

7. The system of claim 1, wherein the plurality of action execution requests is a batch of wire transfer requests.

8. A computer-implemented method comprising:
receiving, by a processor, a plurality of action execution requests, each action execution request including action execution information;
temporarily placing the plurality of action execution requests in a future execution queue to await future execution by one or more action execution applications;
providing, by the processor, the action execution information as input to a trained machine-learning model previously trained on training data comprising historical action execution information associated with a plurality of historical actions executed by one or more action execution applications to detect a duplicate action execution request within the plurality of historical action execution requests by recognizing one or more patterns within the historical action execution information;
generating, by the trained machine-learning model, an output determining that an action execution request of the plurality of action execution requests in the future execution queue is a duplicate action execution request; and
removing the duplicate action execution request from the future execution queue.

9. The method of claim 8, wherein the historical action execution information used to train the machine-learning model includes historical action execution date and time data.

10. The method of claim 8, wherein the machine-learning model is trained by supervised learning using an artificial intelligence algorithm or series of algorithms selected from the group consisting of a decision tree, a random forest, a support vector machine, and a neural network.

11. The method of claim 8, wherein the machine-learning model is trained using a threshold selected from the group consisting of:
a first threshold that defines a degree of similarity between action execution information that is required in order for an action execution request associated with a pattern detected by the machine-learning model to be identified as a duplicate request;
a second threshold that defines a time interval within which an action execution request associated with a pattern detected by the machine-learning model must be received to be identified as a duplicate request; and
a combination thereof.

12. The method of claim 8, wherein a time delay is imposed between placing the plurality of action execution requests in the future execution queue and transmitting the plurality of action execution requests from the future execution queue to the one or more action execution applications for execution of the actions.

13. The method of claim 8, wherein the duplicate action execution request in the future execution queue is removed therefrom by a duplicate action execution request removal module.

14. The method of claim 8, wherein the plurality of action execution requests is a batch of wire transfer requests.

15. A non-transitory computer-readable medium comprising instructions that are executable by a processor for causing the processor to perform operations comprising:
accessing training data comprising historical action execution information associated with a plurality of historical actions executed by one or more action execution applications;
training a machine-learning model on the training data to produce a trained machine-learning model trained to detect a duplicate action execution request by recognizing one or more patterns within the historical action execution information;
receiving a plurality of action execution requests for execution, each action execution request of the plurality of action execution requests including action execution information;
temporarily placing the plurality of action execution requests in a future execution queue to await future execution by the one or more action execution applications;
providing, as input data to the trained machine-learning model, the action execution information associated with the action execution requests in the future execution queue;
generating, by the trained machine-learning model, an output determining that an action execution request of the action execution requests in the future execution queue is a duplicate action execution request; and
outputting a notification identifying the duplicate action execution request for removal from the future execution queue.

16. The non-transitory computer-readable medium of claim 15, wherein the historical action execution information includes historical action execution date and time data.

17. The non-transitory computer-readable medium of claim 15, wherein the machine-learning model is trainable by supervised learning using an artificial intelligence algorithm or series of algorithms selected from the group consisting of a decision tree, a random forest, a support vector machine, and a neural network.

18. The non-transitory computer-readable medium of claim 15, wherein the operations further comprise, during training of the machine-learning model, applying a threshold selected from the group consisting of:
a first threshold that defines a degree of similarity between action execution information that is required in order for an action execution request associated with a pattern detected by the machine-learning model to be identified as a duplicate request;
a second threshold that defines a time interval within which an action execution request associated with a pattern detected by the machine-learning model must be received to be identified as a duplicate request; and
a combination thereof.

19. The non-transitory computer-readable medium of claim 15, wherein the operations further comprise imposing a time delay between placing the plurality of action execution requests in the future execution queue and transmitting the plurality of action execution requests from the future execution queue to the one or more action execution applications for execution of the actions.

20. The non-transitory computer-readable medium of claim 15, further comprising a duplicate action execution request removal module to remove identified duplicate action execution requests from the future execution queue.
